(19) United States
(12) Patent Application Publication
(10) Pub. No.: US 2017/0316161 A1
(43) Pub. Date: Nov. 2, 2017

(54) AUTOMATED SYSTEM AND METHOD FOR CONTENT MANAGEMENT AND COMMUNICATION BASED ON PATIENT DATA

(71) Applicants: Barry Corel Sudduth, Central, SC (US); Robert Barger Hanson, Mobile, AL (US)

(72) Inventors: Barry Corel Sudduth, Central, SC (US); Robert Barger Hanson, Mobile, AL (US)

(21) Appl. No.: 15/582,414

(22) Filed: Apr. 28, 2017

Related U.S. Application Data
(60) Provisional application No. 62/329,039, filed on Apr. 28, 2016.

(51) Int. Cl. G06F 19/00; G06F 17/30; G06F 21/62; G06F 21/10

(52) U.S. Cl. CPC G06F 19/322; G06F 21/6245; G06F 17/30991; G06F 21/10

(57) ABSTRACT

An automated system and method for content management and communication based on patient data are provided. A series of index codes are generated by a processor and tied to medical data such that each index code corresponds to a piece of medical information or medical classification. A series of digital content uploaded to a content repository is tied to one or more of the index codes based on the nature of the digital content. Patient medical information is received by the system and analyzed by a processor within the system to determine medical data applicable to the patient. The medical data applicable to the patient is compared to the medical data tied to the index codes to determine one or more index codes applicable to the patient. Using the index codes applicable to the patient, the processor autonomously assigns digital content within the content repository to the patient.

### CROSS-REFERENCE TO RELATED APPLICATIONS

This application claims priority to U.S. Provisional Patent Application No. 62/329,039, entitled “An automated, patient-data guided, content management and communication system for patient and/or clinical staff education and care management,” filed Apr. 28, 2016, which application is incorporated herein in its entirety.

### FIELD OF THE DISCLOSURE

The subject matter of the present disclosure refers generally to an automated system and method for content management and communication based on patient data.

### BACKGROUND

During medical visits, patients are routinely provided instructions and information relevant to their particular health issue. Often times, however, patients do not follow the instructions or cannot remember the information provided during their visit. Such noncompliance and mental lapses may be attributable to various causes including the physician's use of medical jargon during the patient's visit, the patient having diminished capacity at the time of instruction due to their illness, stress upon the patient, and/or side effects resulting from medication taken by the patient. Regardless of the cause, failure to follow physician instructions frequently results in prolonged illness and worsening symptoms for the patient. Thus, depending on the patient and the illness, noncompliance with physician instructions may be life threatening. Moreover, the inability to recall information or instructions relevant to the patient's illness or treatment plan may result in increased patient anxiety, e.g., not knowing what to expect before a scheduled surgery.

Attempts to solve the problems identified above have been made within the art in the form of systems designed to refresh patient recollection by providing, or making available, digital content to patients. However, systems of this kind generally require significant human intervention due to known systems' inability to autonomously and effectively associate digital content with patient information. In turn, such systems generally require a physician or other medical professional to assess a patient's medical information, manually select digital content, and manually assign the selected digital content to a patient. Accordingly, utilizing known systems of this kind generally requires a significant amount of time and attention from physicians, which, in turn, detracts time and attention away from treating patients or fulfilling other duties.

To save time and effort, physicians may forego the use of such systems altogether. Alternatively, physicians may delegate the manual tasks required during use of the system to other medical professionals, such as a nurse or clerical agent. Accordingly, in some instances, the individual selecting content for a patient may be less familiar with the patient or the patient's illness as the treating physician, thereby increasing the risk of a patient being assigned wrong or inapplicable digital content. Thus, known systems of this kind are largely inefficient, often ineffective, and subject to error due to their reliance on human intervention.

Accordingly, there is a need in the art for a system and method capable of assigning pertinent digital content to a patient without human intervention.

### SUMMARY

An automated system and method for content management and communication based on patient data are provided. Generally, the system and method of the present disclosure are designed to automatically assign digital content based on a patient's medical information such that the assigned content may be accessed by patients, physicians, and/or other authorized users. To facilitate automated assignment of digital content, the method of the present disclosure uses a plurality of index codes stored within an index tag database. Each index code has medical data tied thereto such that each index code corresponds to a piece of medical information or a medical classification. In a preferred embodiment, the medical data tied to the index codes corresponds to a medical diagnosis, medical procedure, medication, or a combination thereof

A plurality of digital content is uploaded to a content repository operably connected to a processor. Preferably, the plurality of digital content uploaded to the content repository comprises digital content having medical information therein. Each piece of digital content uploaded to the content repository is analyzed by the processor and subsequently tied to zero or more index codes based on the nature of the content within the digital content. For instance, a piece of digital content regarding patient preparation for arthroscopic knee surgery may have an index code corresponding to knee surgery tied thereto.

Once the index codes are established and the plurality of content is uploaded to the content repository, a patient's medical information is received by a patient health information interface. The patient health information interface subsequently stores the patient's medical information within a patient database operably connected to the processor for later use. The processor subsequently analyzes the patient's medical information to determine what medical data is applicable to the patient. In a preferred embodiment, the processor analyzes the patient's medical information to determine what diagnosis, procedures, medications, or combinations thereof correspond to the patient's condition. For instance, analyzing patient medical information indicating a sudden onset of pain and swelling around a patient's ankle may result in the processor determining medical data corresponding to a diagnosis of ligament damage or ligament surgery is applicable to the patient.

The medical data determined to be pertinent to the patient is subsequently compared to the medical data tied to the index codes within the index tag database to determine one or more index codes that are applicable to the patient. Thus, in the example provided above, the processor would determine index codes related to ligament damage or ligament surgery are applicable to the patient. The processor subsequently retrieves pieces of digital content, e.g., a video related to ankle ligament surgery or digital pamphlet describing ligaments associated with the ankle, from the content repository that have the same index codes as the index codes found applicable to the patient. Digital content retrieved in this manner is subsequently assigned to a patient's profile within the patient database.

Accordingly, by generating index codes and associating them with medical data, tying such index codes to digital content, and deriving index codes from a patient's medical information, the method of the present disclosure enables a system to autonomously associate digital content with patient information. Thus, by alleviating the need for human intervention in order to assign content to a patient, the method of the present disclosure improves upon what is known in the art and generally serves to alleviate the ineffectiveness, inefficiency, and error commonly associated therewith.

In a preferred embodiment, the digital content retrieved by the processor is tied to the patient's profile such that the digital content may be accessed by the patient or other authorized users via a patient user interface, or by physicians or other medical professionals via a physician user interface. To safeguard information and content within or tied to a patient's profile, access to a patient's profile within the patient database may be limited by a permission level associated with the user attempting such access. In one preferred embodiment, the processor may notify a user upon assigning digital content to a patient's profile and/or monitor engagement with the assigned content. To refine the number or type of digital content within the content repository retrievable by the processor, a user with proper credentials may access the content repository and select certain digital content therein such that the processor may retrieve only selected digital content.

To carry out the various operations disclosed above, the system of the present disclosure generally comprises an index tag database, a content repository, a patient database, a patient health information interface operably connected to the patient database, a processor, and a non-transitory computer-readable medium coupled to the processor. The non-transitory computer-readable medium has instructions stored thereon, which, when executed by the processor, cause the system to perform operations disclosed herein.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTON OF THE DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is an exemplary diagram of a client of FIG. 1 according to an implementation consistent with the principles of the present disclosure.

FIG. 3 is a diagram of an example computing device and mobile computing device.

FIG. 4 is a flow chart illustrating certain method steps of a method for assigning content consistent with the principles of the present disclosure.

FIG. 5 is a diagram illustrating a system embodying features consistent with the principles of the present disclosure.

FIG. 6 is a diagram illustrating the manner in which individual access to data may be limited based on patient, physician, or system roles.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “created vector” and grammatical equivalents refers to the one or more vectors created by the processor based on the mapped activation levels of the one or more sensors.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As will be evident from the disclosure provided below, the present invention satisfies the need for a system and method capable of assigning pertinent digital content a patient without human intervention, and thereby improving upon known systems currently employed within the art.

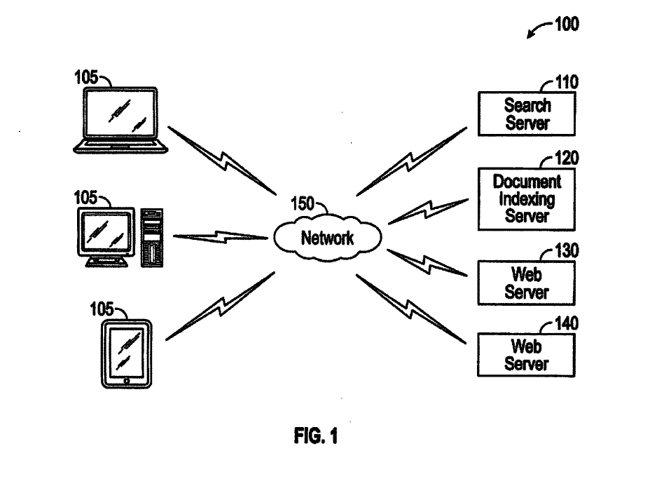

FIG. 1 is a diagram of an example environment 100 in which techniques described herein may be implemented. Environment 100 may include multiple clients 105 connected to one or more servers 110-140 via a network 150. In some implementations, and as illustrated, server 110 may be a search server, that may implement a search engine; and server 120 may be a document indexing server, e.g., a web crawler; and servers 130 and 140 may be general web servers, such as servers that provide content to clients 105. Clients 105 and servers 110-140 may be connected to network 150 via wired, wireless, or a combination of wired and wireless connections.

Three clients 105 and four servers 110-140 are illustrated as connected to network 150 for simplicity. In practice, there may be additional or fewer clients and servers. Also, in some instances, a client may perform the functions of a server and a server may perform the functions of a client.

Clients 105 may include devices of users that access servers 110-140. A client 105 may include, for instance, a personal computer, a wireless telephone, a personal digital assistant (PDA), a laptop, a smart phone, a tablet computer, or another type of computation or communication device. Servers 110-140 may include devices that access, fetch, aggregate, process, search, provide, and/or maintain documents. Although shown as single components 110, 120, 130, and 140 in FIG. 1, each server 110-140 may, in some implementations, be implemented as multiple computing devices, which potentially may be geographically distributed.

Search server 110 may include one or more computing devices designed to implement a search engine, such as a documents/records search engine, general webpage search engine, etc. Search server 110 may, for example, include one or more web servers to receive search queries and/or inputs from clients 105, search one or more databases in response to the search queries and/or inputs, and provide documents or information, relevant to the search queries and/or inputs, to clients 105. In some implementations, search server 110 may include a web search server that may provide webpages to clients 105, where a provided webpage may include a reference to a web server, such as one of web servers 130 or 140, at which the desired information and/or links is located. The references, to the web server at which the desired information is located, may be included in a frame and/or text box, or as a link to the desired information/document.

Document indexing server 120 may include one or more computing devices designed to index documents available through network 150. Document indexing server 120 may access other servers, such as web servers that host content, to index the content. In some implementations, document indexing server 120 may index documents/records stored by other servers, such as web servers 130 and 140 and, connected to network 150. Document indexing server 120 may, for example, store and index content, information, and documents relating to user accounts and user-generated content.

Web servers 130 and 140 may each include web servers that provide webpages to clients. The webpages may be, for example, HTML-based webpages. A web server 130/140 may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

While servers 110-140 are shown as separate entities, it may be possible for one or more servers 110-140 to perform one or more of the functions of another one or more of servers 110-140. For example, it may be possible that two or more of servers 110-140 are implemented as a single server. It may also be possible for one of servers 110-140 to be implemented as multiple, possibly distributed, computing devices.

Network 150 may include one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks.

Although FIG. 1 shows example components of environment 100, in other implementations, environment 100 may contain fewer components, different components, differently arranged components, and/or additional components than those depicted in FIG. 1. Alternatively, or additionally, one or more components of environment 100 may perform one or more other tasks described as being performed by one or more other components of environment 200.

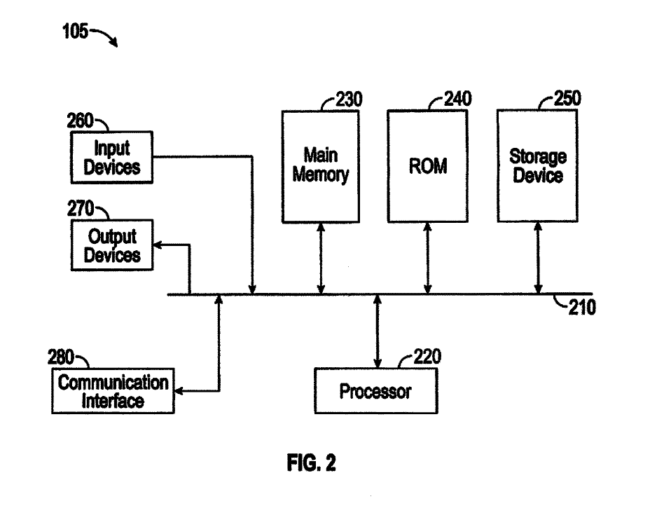

FIG. 2 is an exemplary diagram of a user/client 105 or server entity (hereinafter called “client/server entity”), which may correspond to one or more of the clients and servers, according to an implementation consistent with the principles of the invention. The client/server entity 105 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity 105.

Processor 220 may include any type of conventional processor or microprocessor that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity 105, such as a scanner, phone, camera, scanning device, keyboard, a mouse, a pen, voice recognition and/or biometric mechanisms, etc. Output device(s) 270 may include one or more conventional mechanisms that output information to the operator, including a display, a printer, a speaker, an alarm, a projector, etc. Communication interface 280 may include any transceiver-like mechanism that enables the client/server entity 105 to communicate with other devices 105 and/or systems. For example, communication interface 280 may include mechanisms for communicating with another device 105 or system via a network, such as network 150.

As will be described in detail below, the client/server entity 105, consistent with the principles of the invention, performs certain receiving, communicating, generating, output providing, correlating, and storing operations. The client/server entity 105 may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as read-only memory (ROM), random access memory (RAM), flash memory, and the like. The software instructions contained in memory 230 causes processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

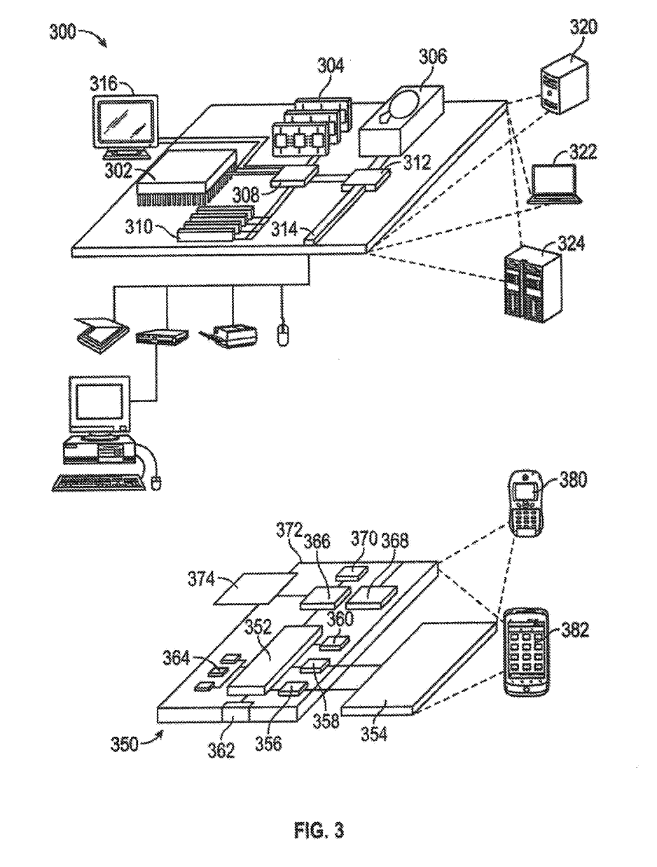

FIG. 3 is a diagram of an example of a computing device 300 and a mobile computing device 350, which may be used with the techniques described here. Computing device 300 or mobile computing device 350 may correspond to, for example, a client 205 and or a server 210-240. Computing device 300 is intended to represent various forms of digital computers, such as laptops, desktops, workstations, personal digital assistants, servers, mainframes, and other appropriate computers. Mobile computing device 350 is intended to represent various forms of mobile devices, such as scanners, scanning devices, personal digital assistants, cellular telephones, smart phones, tablet computers, and other similar computing devices. The components show in FIG. 3, their connections and relationships, and their functions, are meant to be examples only, and are not meant to limit implementations described herein.

Computing device 300 may include a processor 302, a memory 304, a storage device 306, a high-speed interface 308 connecting to a memory 304 and high-speed expansion ports 310, and a low-speed interface 312 connecting to a low-speed expansion port 314 and a storage device 306. Each of components 302, 304, 306, 308, 310, 312, and 314 are interconnected using various buses, and may be mounted on a common motherboard or in other manners as appropriate. Processor 302 can process instructions for execution within computing device 300, including instructions stored in memory 304 or on storage device 306 to display graphical information for a graphical user interface (GUI) on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations, as a server bank, a group of blade servers, or a multi-processor system, etc.

Memory 304 stores information within computing device 300. In some implementations, memory 304 includes a volatile memory unit or units. In another implementation, memory 304 may include a non-volatile memory unit or units. Memory 304 may also be another form of computer-readable medium, such as a magnetic or optical disk. A computer-readable medium may refer to a non-transitory memory device. A memory device may refer to storage space within a single storage device or spread across multiple storage devices.

Storage device 306 is capable of providing mass storage for computing device 300. In some implementations, storage device 306 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or a memory on processor 302.

High-speed interface 308 manages bandwidth-intensive operations for computing device 300, while low-speed interface 312 manages lower bandwidth-intensive operations. Such allocation of functions is an example only. In some implementations, high-speed interface 308 is coupled to memory 304, display 316, such as through a graphics processor or accelerator, and to high-speed expansion ports 310, which may accept various expansion cards. In this implementation, low-speed interface 312 may be coupled to storage device 306 and low-speed expansion port 314. Low-speed expansion port 314, which may include various communication ports, such as USB, Bluetooth, Ethernet, wireless Ethernet, etc., may be coupled to one or more input/output devices, such as a keyboard, a pointing device, a scanner, or a networking device such as switch or router, e.g., through a network adapter.

Computing device 300 may be implemented in a number of different forms, as shown in the figures. For example, computing device 300 may be implemented as a standard server 320, or in a group of such servers. Computing device 300 may also be implemented as part of a rack server system 324. In addition, computing device 300 may be implemented in a personal computer, such as a laptop computer 322. Alternatively, components from computing device 300 may be combined with other components in a mobile device, such as mobile computing device 350. Each of such devices may contain one or more computing devices 300, 350, and an entire system may be made up of multiple computing devices 300, 350 communicating with each other.

Mobile computing device 350 may include a processor 352, a memory 364, an input/output (“I/O”) device, such as a display 354, a communication interface 366, and a transceiver 368, among other components. Mobile computing device 350 may also be provided with a storage device, such as a micro-drive or other device, to provide additional storage. Each of the components 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a TFT LCD (Thin-Film-Transistor Liquid Crystal Display) or an OLED (Organic Light Emitting Diode) display or other appropriate display technology. Display interface 356 may include appropriate circuitry for driving display 354 to present graphical and other information to a user. Control interface 358 may receive commands from a user and convert the commands for submission to processor 352. In addition, an external interface 362 may be provided in communication with processor 352, so as to enable near area communication of mobile computing device 350 with other devices. External interface 362 may provide, for example, for wired communications in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for device 350, or may also store applications or other information for mobile computing device 350. Specifically, expansion memory 374 may include instructions to carry out or supplement the processes described herein, and may include secure information also. Thus, for example, expansion memory 374 may be provided as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described herein. The information carrier is a computer-or machine readable-medium, such as memory 364, expansion memory 374, or a memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS or MMS messaging, CDMA, TDMA, PDC, WCDMA, CDMA2000, or GPRS, among others. Such communication may occur, for example, through transceiver 368. In addition, short-range communication may occur, such as using a Bluetooth, WiFi, or other such transceiver. In addition, GPS (Global Positioning System) received module 370 may provide additional navigation-and location-related wireless data to mobile computing device 350, which may be used as appropriate by applications running on mobile computing device 350.

Mobile computing device 350 may also communicate audibly using audio codec 360, which may receive spoken information from a user and covert the received spoken information to digital information. Audio codec 360 may likewise generate audible sound for a user, such as through a speaker, e.g., in a handset of mobile computing device 350. Such sound may include sound from voice telephone calls, may include recorded sound, such as voice messages, music files, etc., and may also include sound generated by applications operating on mobile computing device 350.

Mobile computing device 350 may be implemented in a number of different forms, as shown in the figure. For example, mobile computing device 350 may be implemented as a cellular telephone 380. Mobile computing device 350 may also be implemented as part of a smart phone 382, personal digital assistant, or other similar mobile device.

Various implementations described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The contents of computer-readable medium may physically reside in one or more memory devices accessible by server. Computer-readable medium may include a database of entries corresponding to certain subject matter disclosed herein. A user or organization's information may be provided in information fields and stored in a database, as set forth herein. Said fields are customizable and may include additional or alternative fields based on the user's needs. Said information is accessible through the server.

To provide for interaction with a user, the techniques described herein can be implemented on a computer having a display device, such as a CRT (cathode ray tube), LCD (liquid crystal display), or LED (Light Emitting Diode) monitor, for displaying information to the user and a keyboard and a pointing device by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The techniques described herein can be implemented in a computing system that includes a back end component, such as a data server, or that includes a middleware component, such as an application server, or that includes a front end component, such as a client computer having a graphical user interface or Web browser through which a user can interact with an implementation of the techniques described here, or any combination of such back end, middleware, or front end components.

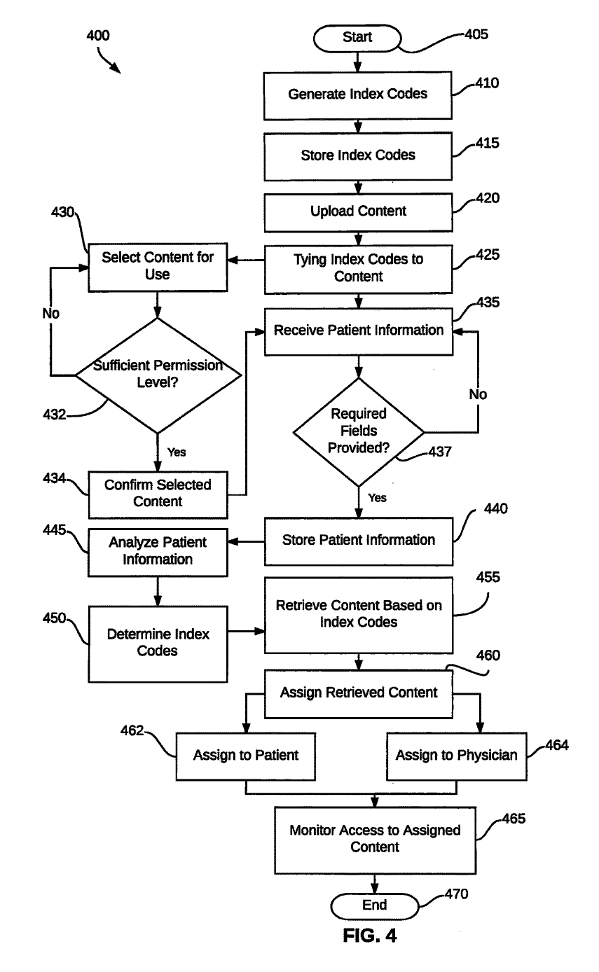

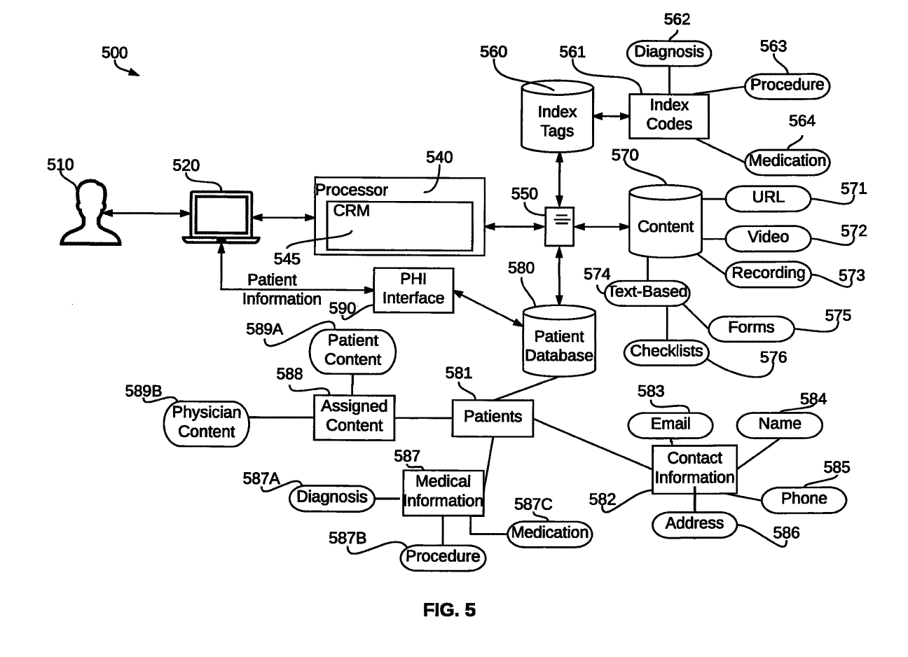

FIGS. 4 and 5 illustrate preferred embodiments of a method and system, respectively, for autonomous assignment of digital content based on patient data. FIG. 4 is a flow chart 400 illustrating various method steps that may be carried out to perform the method of the present disclosure. It is understood that the various method steps associated with the method of the present disclosure may be carried out as operations by the system 500 of the present disclosure.

As shown in FIG. 5, the system 500 of the present disclosure generally comprises an index tag database 560, a content repository 570, a patient database 580, a patient health information interface 590 operably connected to the patient database 580, and a processor 540 operably connected to the index tag database 560, the content repository 570, and the patient database 580. As shown in FIG. 5, in one preferred embodiment, the processor 540 is operably connected to the index tag database 560, the content repository 570, and the patient database 580, via a server 550, such that the processor may send or retrieve information from the databases and repository via the server 550. Although represented as a single server within FIG. 5, it is understood that multiple servers may be used to operably connect the processor 540 to the index tag database 560, the content repository 570, and the patient database 580. The processor 540 may be operably connected to the server 550 via wired or wireless connection.

The processor 540 is configured to perform the operations disclosed herein based on programming instructions stored within the system 500. The processor 540 may be any processor or microprocessor suitable for executing such program instructions. In some embodiments, the processor 540 may have a memory device therein suitable for storing the data, content, or other information or material disclosed herein. In some instances, the processor 540 may be a component of a larger computing device. Computing devices that may house the processor 540 therein may include, but are not limited to, laptops, desktops, workstations, personal digital assistants, servers, mainframes, cellular telephones, tablet computers, or any other similar device. Accordingly, the inventive subject matter disclosed herein, in full or in part, may be implemented or utilized in devices including, but not limited to, laptops, desktops, workstations, personal digital assistants, servers, mainframes, cellular telephones, tablet computers, or any other similar device.

In a preferred embodiment, the programming instructions responsible for the operations carried out by the processor 540 are stored on a non-transitory computer-readable medium 545 that is coupled to the processor 540, as shown in FIG. 5. Alternatively, the programming instructions may be stored or included within the processor 540. Examples of non-transitory computer-readable mediums 545 include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions may be stored as modules within the non-transitory computer-readable medium 545.

As shown in FIG. 5, the index tag database 560 is configured to store a plurality of index codes 561 and the medical data 562-564 tied to the index codes therein. The index tag database 560 may be a relational database such that the plurality of index codes 561 and medical data 562-564 tied thereto may be stored in one or more tables. Alternatively, the index tag database 560 may be an object database such that the plurality of index codes 561 and medical data are stored as objects. In another alternative embodiment, the index tag database 560 may be a data file having the plurality of index codes 561 and medical data therein, e.g., a digital spreadsheet.

The content repository 570 is configured to store various types of digital content therein. As shown in FIG. 5, such digital content may include, but is not limited to, URLs 571, digital video 572, sound recordings 573, text-based content 574 including medical forms 575 and checklists 576. To efficiently manage data traffic, i.e., the amount of digital content uploaded to and downloaded from the content repository 570, the content repository 570 may comprise one or more servers dedicated solely for receiving uploaded digital content and communicating such content to the processor 540. In one preferred embodiment, the content repository 570 may comprise a number of servers equal to the number of different content types stored by the content repository 570. For instance, in one embodiment, the content repository 570 may comprise a total of four different servers: a server dedicated to managing URL content 571, a server dedicated to managing video content 572, a server dedicated to managing sound recording content 573, and a server dedicated to managing text-based content 574.

The patient database 580 is configured to store a plurality of patient profiles 581 therein and the various information, data, and/or content tied to or associated with such profiles. Such information, data, and/or content may include, but is not limited to patient contact information 582, patient medical information 587, and assigned content 588, as disclosed herein. The patient database 580 may be a relational database such that the contact information 582, medical information 587, and/or assigned content 588 associated with each patient profile within the plurality of patient profiles 581 may be stored, at least in part, in one or more tables. Alternatively, the patient database 580 may be an object database such that the contact information 582, medical information 587, and/or assigned content 588 associated with each patient profile within the plurality of patient profiles 581 are stored, at least in part, as objects. In some instances, the patient database 580 may comprise a relational and/or object database and a server dedicated solely to managing the content assigned to patient profiles in the manner disclosed herein.

Although the index tag database 560, the content repository 570, and the patient database 580 are represented as separate entities within FIG. 5, it is understood that data, information, and/or content stored within each database or repository, as disclosed herein, may be stored within a single database without departing from the inventive subject matter disclosed herein.

To populate the patient database 580, the system 500 utilizes a patient health information interface 590. The patient health information interface 590 is operably connected to the patient database 580 such that information may be transferred from the patient health information interface 590 to the patient database 580, or vice versa. The patient health information interface 590 is configured to receive patient information and subsequently store such information within a patient's profile within the patient database 580. In a preferred embodiment, patient information is provided to the patient health information interface 590 by a user 510 inputting or uploading patient information to a user interface 520 hosted on a suitable computing device, such as a desktop, laptop, or tablet computer. Thus, in some embodiments, the patient health information interface 590 may be back-end hardware, such as a server, and/or software operably connected to the user interface 520.

FIG. 4 provides a flow chart 400 illustrating certain, preferred method steps that may be used to carry out the method of the present disclosure. Step 405 indicates the beginning of the method. In index code generation step 410, a plurality of index codes 561 are generated by the processor 540 and subsequently stored in step 415 within the index tag database 560. To store the index codes generated by the processor 540, the server 550 may retrieve the index codes form the processor 540 and subsequently transfer them to the index tag database 560. Each index code within the plurality of index codes 561 has one or more pieces of medical data tied thereto. The medical data tied to each index code corresponds to a defined piece or set of medical information and/or medical classification. For instance, the medical data tied to an index code may correspond to a field of medicine, a particular diagnosis, a medical procedure, or a combination thereof.

In one preferred embodiment, the medical data tied to the index codes within the index tag database 560 may be diagnosis data 562, procedure data 563, medication data 564, or a combination thereof, as shown in FIG. 5. In such embodiments, the diagnosis data 562 contains information related to medical diagnosis, the procedure data 563 contains information related to medical procedures, and medication data 564 contains information related to medications and/or medical devices. To remain consistent with standardized coding classifications currently used within the field, it is generally preferred that index codes having diagnosis data 562 or procedure data 563 tied thereto be consistent with current International Classification of Disease (ICD) and Current Procedural Terminology (CPT) standards, respectively. For instance, an index code having diagnosis data 562 tied thereto relating to respiratory tuberculosis may be formatted to have an alphanumeric code of “A15.0,” as is consistent with ICD standards. Similarly, an index code having procedure data 563 tied thereto relating to the procedure of giving a chicken pox vaccine may be formatted to have a numeric code of “90716,” as is consistent with CPT standards. In some instances, the entirety of the plurality of index codes 561 may be generated by the processor 540 using ICD and/or CPT codes.

In content generation step 420, a plurality of digital content is uploaded to the content repository 570. In a preferred embodiment, the non-transitory computer-readable medium 545 may have programming instructions stored thereon, which, when executed by the processor 540 cause the processor 540 to retrieve digital content from a defined, external system, such as a physician's work computer, and subsequently upload it to the content repository 570. In such embodiments, the processor 540 may be operably connected to the defined, external system via a wired or wireless connection. In some instances, the processor 540 may be operably connected to a plurality of external systems from which digital content may be retrieved therefrom via a network 150.

In another preferred embodiment, users may select content to upload to the content repository 570 using a user interface 520 operably connected to the processor 540. In such embodiments, users may uploaded content to the content repository 570 by transmitting the desired content to the processor 540, which subsequently transmits the content to the content repository 570 via the server 550. Alternatively, the system 500 may be designed such that users may directly upload digital content from their local computing system to the content repository 570 via one or more servers. In some embodiments, a user's ability to upload digital content either to the processor 540 or to the content repository 570 directly may be limited based on a user's permission level, as disclosed herein.

Preferably, the plurality of digital content uploaded to the content repository 570 comprises digital content having medical information therein. The form of digital content uploaded to the content repository 570 may include but is not limited to, URLs 571 to webpages, digital videos 572, sound recordings 573, and text-based content 574 such as medical forms 575 or medical checklists 576. In step 425, each piece of digital content uploaded to the content repository 570 is analyzed and subsequently tied to zero or more index codes within the plurality of index codes 561 based on the nature of the content within the digital content. If no index code within the index tag database 160 corresponds to the nature of content within a piece of digital content, no index code is tied to the digital content, thereby rendering the digital content ineligible for assignment to a patient profile, as disclosed herein.

To improve processor 540 efficiency while analyzing the uploaded digital content, the processor 540 may tie index codes within the plurality of index codes 561 to each piece of digital content within the content repository 570 based on one or more tags tied to or associated with the digital content. The term “tag” as used herein in relation to digital content within the content repository 570 is understood to mean a title and/or alphabetic, numeric, symbolic, or combination thereof, classification assigned to a piece of digital content. For instance, a piece of digital content entitled “Preparation for Arthroscopic Knee Surgery” may be tied to an index code having procedure data pertaining to knee surgery tied thereto. As the foregoing example evidences, the processor 540 preferably conducts a word-based inquiry upon the digital content to analyze and subsequently tie index codes thereto. However, one of skill in the art will appreciate that other techniques for analyzing and assigning index codes to the digital content may be employed without departing from the inventive subject matter disclosed herein. In some embodiments, the system 500 may be configured such that one or more tags must be assigned to a piece of digital content before the digital content may be uploaded to the content repository 570. Alternatively, the system 500 may be configured such that tags may be assigned to a piece of digital content after it has been uploaded to the content repository.

As illustrated in FIG. 4, in some embodiments the method of the present disclosure may further comprise content selection step 430 to reduce redundancy or to enable physicians to tailor content within the content repository 570. In content selection step 430, digital content within the content repository 570 is selected, and thus made eligible for assignment to a patient's profile within the patient database 580. Conversely, digital content not selected is rendered ineligible for assignment for to a patient's profile. For instance, the content repository 570 may have ten videos related to Type II Diabetes stored therein, but a group of physicians may only wish to select one or two to be assigned to their diabetic patients.

To access the digital content stored within the content repository 570, users 510 may be required to make a request to access the data via a user interface 520. To guard the content repository 570 from unwanted manipulation, access to the content repository 570 may be granted or denied by the processor 540 based on the processor's 540 verification of a user's 510 permission level in permission level step 432. If the user's permission level is sufficient, the processor 540 provides the user access to the content repository 570. Conversely, if the user's permission level is insufficient, the processor 540 will deny the user such access.

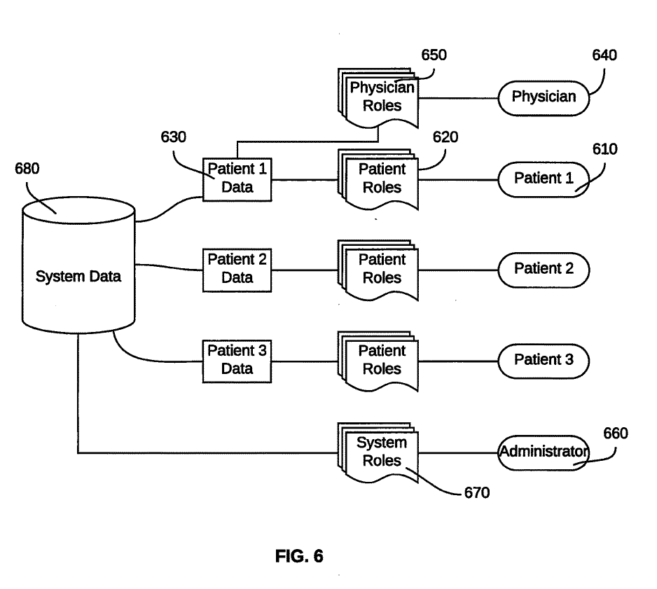

In a preferred embodiment, user permission levels are based on physician roles 650, patient roles 620, and system roles 670, as shown in FIG. 6. Physician roles 650 allow physicians 640 to access patient data 630 within the patient database 580 related to their patients. Patient roles allow patients 610 (or users authorized by the patient) to access the patient data 630 tied to their own patient profile within the patient database 580. System roles 670 allow administrators 660 to access system wide data 680. In a preferred embodiment, access to the content repository 570 may be limited only to those users 510 having physician roles 650 or system roles 670 associated therewith. In some instances, a physician 640 may also serve as an administrator 660. Prior to finalizing any selections made within the content repository 570 by users 510 having access thereto, the user 510 may be presented with one or more prompts to confirm the user's desire to finalize the selections made in selection confirmation step 434.

In order to determine which pieces of digital content within the content repository 570 are pertinent to a patient's particular health issue, patient information is uploaded to the system 500. As shown in FIG. 5, in a preferred embodiment, patient information is uploaded to the patient health information interface 590 in information acquisition step 435. In a preferred embodiment, a user 510, such as a physician, may upload patient information to the system via a user interface 520 operably connected to the patient health information interface 590. In such embodiments, the user interface 520 is designed such that the user interface 520 complies with Health Level 7 (HL7) standards. Preferably, the user interface 520 supports both manual inputting as well as importation of patient information. One of skill in the art will appreciate, however, that patient information may be provided to the patient health information interface 520 in other suitable manners without departing from the inventive subject matter disclosed herein. For instance, in some embodiments, the patient health information interface 590 may be operably connected to external systems and/or databases such that patient health information interface 590 may retrieve patient information stored thereon.

Once patient information is received, the patient health information interface 590 stores the patient information within the patient database 580, such that the patient's information is tied to the patient's profile within the patient database 580 in step 440. For first-time patients, the creation of a new patient profile may be required before the patient's information can be stored within the patient database 580. In alternative embodiments, patient information may be uploaded directly to the patient database 580 or provided to the processor 540, which subsequently transmits and stores such information to the patient database 580 via a server 550.

When providing patient information to the patient health information interface 590, certain fields may be required before the patient's information can be stored within the patient database. Accordingly, in one preferred embodiment, the method of the present disclosure may further comprise an information verification step 437. During the information verification step 437, the patient health information interface 590 reviews the patient information provided to assess whether all required fields have been inputted. If all required fields have been inputted, the patient health information interface 590 subsequently stores the information within the patient database 580. If a user 510 fails to provide one or more required fields, the patient health information interface 590 may prompt the user 510 to input the missing fields of information.

Required information fields may include, but is not limited to, information relating to the patient's medical information 587 and information relating to the patient's contact information 583. As shown in FIG. 5, medical information 587 may include, but is not limited to, information relating to a patient's diagnosis 587A, information relating to procedures performed on or suggested for the patient 587B, and information related to medication taken or prescribed to the patient 587C. Patient contact information 582 may include, but is not limited to, patient email 583, patient name 584, patient phone number 585, and patient address 586. In some embodiments, the contact information of the patient's treating physician may be tied to the patient's profile. Preferably, each patient profile within the plurality of patient profiles 581 within the patient database 580 has the medical information 587 and contact information 582 outlined above tied thereto.

Once a patient's information is stored within the patient database 580, the processor 540 subsequently analyzes the medical information 587 to determine what medical data is applicable to the patient in step 445. In one preferred embodiment, processor 540 conducts a key word inquiry upon the medical information 587 such that the processor 540 searches the medical information 587 for key words or phrases associated with particular diagnoses, procedures, medications, fields of medicine, or other similar types of information. For instance, if the medical information 587 within a patient's profile has the phrase “coughing up blood” therein, the processor 540 may determine medical data related to respiratory tuberculosis is applicable to the patient. Although one of skill in the art will appreciate that other techniques may be employed to determine medical data from the patient's medical information 587 without departing from the inventive subject matter disclosed herein.

Medical data determined to be applicable to the patient is subsequently compared by the processor 540 to the medical data 562-564 tied to the plurality of index codes 561 within the index tag database 560 to determine one or more index codes that are applicable to the patient in step 450. In a preferred embodiment, the processor 540 determines index codes applicable to the patient by identifying matches between the medical data applicable to the patient and the medical data 562-564 tied to the index codes. The processor 540 may be configured to only identify index codes having medical data 562-564 attached thereto perfectly matching the medical data applicable to the patient as applicable to the patient. However, one of skill in the art will appreciate the criteria by which the processor 540 determines a match between medical data may be adjusted or manipulated to establish more ore less stringent match criteria. In some instances, index codes found applicable to a patient may be stored within the patient database 580 such that the applicable index codes are tied to the patient's profile within the database.

Using the index codes determined to be applicable to the patient in step 450, the processor 540 subsequently retrieves one or more pieces of digital content from the content repository 570 in step 455. In this step, the processor 540 selects digital content to retrieve by comparing the index codes found applicable to the patient to the index codes tied to the digital content. Digital content within the content repository 570 having index codes tied thereto matching the index codes found applicable to the patient is identified and subsequently retrieved by the processor 540. However, one of skill in the art will appreciate the criteria by which the processor 540 determines a match between index codes may be adjusted or manipulated to establish more or less stringent match criteria. Digital content retrieved by the processor 540 is then subsequently assigned to the patient's profile within the patient database 580 in content assignment step 460. Thus, as shown in FIG. 5, each patient profile within the patient database 580 may have one or more pieces of assigned content 588 tied thereto. In some instances, the processor 540 may be further configured to notify a user when digital content is assigned to a patient's profile by using the contact information 582 tied to the patient's profile. For instance, upon assigning a piece of digital content, the processor 540 may send an email to the patient and/or the patient's treating physician indicating such assignment.

In a preferred embodiment, digital content assigned to a patient is tied to the patient's profile within the patient database 580 such that a user 510 may access such content via a user interface 520. To access the digital content, a user 510 makes a user request to the processor 540 to access the patient's profile within the patient database 580. In a preferred embodiment, the processor 540 grants or denies the request based on the permission level associated with the requesting user. As shown in FIG. 6, only users having appropriate patient roles 620, physician roles 650, or system roles 670 may access the data associated with a patient's profile 630. Preferably, individuals assigned physician roles 650 are limited to the patient's treating physicians 640 or other medical professionals. Individuals assigned patient roles 620 are preferably limited to the patient 610 and/or other individuals to which the patient has authorized to access data associated with their profile within the patient database 580. A system administrator 660 may assign patient roles 620 and physician roles 650. Individuals assigned system roles 670 are preferably limited to those individuals charged with managing the system 500 and the data contained therein. Upon submitting a user request to access a patient profile, the processor 540 verifies the user's permission level by comparing the type of role associated with the user and the type of role required for access to the patient profile and subsequently grants or denies access based on such comparison.

In a preferred embodiment, the assigned content 588 tied to a patient's profile within the patient database 580 may be divided into patient content 589A and physician content 589B. Patient content 589A is content assigned to the patient's profile in step 462 and designed for patient use, such as a video detailing a patient's diagnosis or a digital pamphlet providing post-operative instructions. Conversely, physician content 589B is content assigned to the patient's profile in step 464 and designed for use by a physician or other medical professional, such as diagnostic checklists or billing forms relating to the patient's particular health issue. In one preferred embodiment, patient content 589A may be available to users having sufficient patient roles 620, physician roles 650, or system roles 670 via a user interface. In another preferred embodiment, physician content 589B may only be accessible to physicians having sufficient physician roles 650 via a physician user interface operably connected to the system 500. In such embodiments, physicians access physician content 589B by submitting a request to the processor 540 to access the patient's profile. Upon submitting the access request, the processor 540 verifies the physician has a sufficient physician role 650 for such access and subsequently grants or denies access based on such verification.

In some embodiments, the system 500 and method of the present disclosure may be further designed to monitor user access to the digital content assigned to a patient's profile within the patient database 580 in step 465. In such embodiments, the processor 540 is configured to record user engagement with each piece of digital content assigned to the patient's profile. For instance, the processor 540 may record when a patient 610, physician 640, or administrator 660 views or otherwise accesses a piece of digital content tied to a patient's profile. Conversely, the processor 540 may record the absence of access to a piece of digital content assigned to a patient's profile over a given time period. The processor 540 may use such recordings to generate a notification of user engagement with the digital content and subsequently send the notification to a defined user, such as the patient or the patient's treating physician. In this way, the system 500 and method of the present disclosure may serve to alert physicians when a patient has reviewed assigned content concerning their particular health issue or as a reminder for physicians or patients that certain digital content still needs to be accessed. In some embodiments, the system 500 may further comprise a content utilization database to which the processor 540 may store information pertaining to user access to assigned content therein, such as which users have accessed the content, what times they accessed the content, and how many times they accessed the content. Step 470 indicates the end of the method disclosed herein.

Although the system and method of the present disclosure has been discussed for use within the medical field, one of skill in the art will appreciate the inventive subject matter disclosed herein may be utilized in other fields or for other applications in which the automated content assignment or management is needed.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter.

What is claimed is:

1) A method for assigning content, said method comprising the steps of:
generating, by a processor, a plurality of index codes,
wherein each index code within the plurality of index codes has medical data tied thereto;
storing the plurality of index codes within an index tag database;
uploading a plurality of digital content to a content repository;
tying, by the processor, zero or more index codes within the plurality of index codes to each piece of digital content within the plurality of digital content;
receiving, by a patient health information interface, a patient's medical information;
storing, by the patient health information interface, the patient's medical information within a patient database,
wherein the patient database is configured to store a plurality of patient profiles therein;
analyzing, by the processor, the patient's medical information to determine medical data applicable to the patient;
comparing, by the processor, the medical data applicable to the patient to the medical data tied to the plurality of index codes to determine one or more index codes applicable to the patient;
retrieving, by the processor, one or more pieces of digital content from the content repository based on the one or more index codes applicable to the patient; and
assigning, by the processor, the one or more pieces of digital content to a patient's profile within the patient database.

2) The method of claim 1, wherein the medical data is selected from the group consisting of diagnosis data, procedure data, medication data, and combinations thereof.

3) The method of claim 1, further comprising the steps of:
accessing, by a user, the content repository;
selecting, by the user, digital content within the content repository; and
filtering digital content within the content repository such that only digital content selected by the user can be retrieved and assigned by the processor.

4) The method of claim 3, further comprising the steps of:
requesting, by the user via a user interface, access to the content repository,
wherein the user has a permission level associated therewith,
the user's ability to access the content repository being limited by the user's permission level; and
verifying, by the processor, the user's permission level.

5) The method of claim 1, wherein the processor ties index codes within the plurality of index codes to each piece of digital content within the plurality of digital content based on a tag associated with each piece of digital content.

6) The method of claim 1, wherein the step of assigning, by the processor, the one or more pieces of digital content to the patient's profile within the patient database comprises:
tying the one or more pieces of digital content to the patient's profile such that the one or more pieces of digital content may be accessed via a user interface.

7) The method of claim 6, further comprising the steps of:
requesting, by a user via the user interface, access to the patient's profile within the patient database,
wherein the user has a permission level associated therewith,
the user's ability to access the patient's profile being limited by the user's permission level; and
verifying, by the processor, the user's permission level.

8) The method of claim 1, wherein the step of assigning, by the processor, the one or more pieces of digital content to the patient's profile within the patient database comprises:
tying the one or more pieces of digital content to the patient's profile within the patient database such that the one or more pieces of digital content can only be accessed by physicians via a physician user interface.

9) The method of claim 8 further comprising the steps of:
requesting, by a physician via the physician user interface, access to the patient's profile within the patient database,
wherein the physician has a permission level associated therewith,
the physician's ability to access the patient's profile within the patient database being limited by the physician's permission level; and
verifying, by the processor, the physician's permission level.

10) The method of claim 1, wherein each patient profile stored within the patient database has contact information tied thereto, and wherein the method further comprises the step of:
notifying, by the processor, a user of the one or more pieces of digital content assigned to a patient's profile using the contact information tied to the patient's profile.

11) The method of claim 1, further comprising the steps of:
recording, by the processor, a user's engagement with the one or more pieces of digital content assigned to the patient's profile;
generating, by the processor, a notification based on the user's recorded engagement with the one or more pieces of digital content assigned to the patient's profile; and
sending, by the processor, the notification.

12) The method of claim 11, wherein the notification is sent to a physician.

13) A method for assigning content, said method comprising the steps of:
generating, by a processor, a plurality of index codes,
wherein each index code within the plurality of index codes has medical data tied thereto,
3the medical data being selected from the group consisting of diagosis data, procedure data, medication data, and combinations thereof;
storing the plurality of index codes within an index tag database;
uploading a plurality of digital content to a content repository;
tying, by the processor, zero or more index codes within the plurality of index codes to each piece of digital content within the plurality of digital content;
accessing the content repository;
selecting digital content within the content repository;
receiving, by a patient health information interface, a patient's medical information;
storing, by the patient health information interface, the patient's medical information within a patient database,
wherein the patient database stores a plurality of patient profiles therein;
analyzing, by the processor, the patient's medical information to determine medical data applicable to the patient;
comparing, by the processor, the medical data applicable to the patient to the medical data tied to the plurality of index codes to determine one or more index codes applicable to the patient;
retrieving, by the processor, one or more pieces of digital content from the content repository based on the digital content selected within the content repository and the one or more index codes applicable to the patient; and
assigning, by the processor, the one or more pieces of digital content to a patient's profile within the patient database.

14) The method of claim 13, further comprising the steps of:
requesting, by a user via a user interface, access to the content repository,
wherein the user has a permission level associated therewith,
the user's ability to access the content repository being limited by the user's permission level; and
verifying, by the processor, the user's permission level.

15) The method of claim 13, wherein the step of assigning, by the processor, the one or more pieces of digital content to the patient's profile within the patient database comprises:
tying the one or more pieces of digital content to the patient's profile such that the one or more pieces of digital content may be accessed via a user interface, and
wherein the method further comprises the steps of:
requesting, by a user via the user interface, access to the patient's profile within the patient database,
wherein the user has a permission level associated therewith,
the user's ability to access the patient's profile being limited by the user's permission level; and
verifying, by the processor, the user's permission level.

16) The method of claim 13, wherein the step of assigning, by the processor, the one or more pieces of digital content to the patient's profile within the patient database comprises:
tying the one or more pieces of digital content to the patient's profile within the patient database such that the one or more pieces of digital content can only be accessed by physicians via a physician interface, and
wherein the method further comprises the steps of:
requesting, by a physician via the physician interface, access to the patient's profile within the patient database,
wherein the physician has a permission level associated therewith,
the physician's ability to access the patient's profile within the patient database being limited by the physician's permission level, and
verifying, by the processor, the physician's permission level.

17) The method of claim 13, wherein each patient profile stored within the patient database has contact information tied thereto, and wherein the method further comprises the step of:
notifying, by the processor, a user of the one or more pieces of digital content assigned to the patient's profile based on the contact information tied to the patient's profile.

18) The method of claim 17, further comprising the steps of:
recording, by the processor, a user's engagement with the one or more pieces of digital content assigned to the patient's profile;
generating a notification, by the processor, based on the user's engagement with the one or more pieces of digital content assigned to the patient's profile; and
sending, by the processor, the notification.

19) A system for assigning content, said system comprising:
an index tag database;
a content repository;
a patient database;
a patient health information interface,
wherein the patient health information interface is operably connected to the patient database;
a processor,
wherein the processor is operably connected to the index tag database, the content repository, and the patient database;
a non-transitory computer-readable medium coupled to the processor having instructions thereon, which, when executed by the processor, cause the system to perform operations comprising:
generating, by the processor, a plurality of index codes,
wherein each index code within the plurality of index codes has medical data tied thereto;
storing the plurality of index codes within the index tag database;
uploading a plurality of digital content to the content repository;
tying, by the processor, zero or more index codes within the plurality of index codes to each piece of digital content within the plurality of digital content;
receiving, by the patient health information interface, a patient's medical information;
storing, by the patient health information interface, the patient's medical information within the patient database;
analyzing, by the processor, the patient's medical information to determine medical data applicable to the patient;
comparing, by the processor, the medical data applicable to the patient to the medical data tied to the plurality of index codes to determine one or more index codes applicable to the patient;
retrieving, by the processor, one or more pieces of digital content from the content repository based on the one or more index codes applicable to the patient; and
assigning, by the processor, the one or more pieces of digital content to a patient's profile within the patient database.

20) The system of claim 19, further comprising instructions stored on the non-transitory computer-readable medium, which, when executed by the processor causes the processor to perform operations comprising:
recording a user's engagement with the one or more pieces of digital content assigned to the patient's profile;
generating a notification based on the user's engagement with the one or more pieces of digital content assigned to the patient's profile; and
sending the notification.
